(19) United States
(12) Patent Application Publication
(10) Pub. No.: US 2009/0255430 A1
(43) Pub. Date: Oct. 15, 2009

(54) Printing Press

(75) Inventors: Hitoshi Murakami, Hiroshima-ken (JP); Yasuhiko Hirata, Hiroshima-ken (JP)

Correspondence Address: KANESAKA BERNER AND PARTNERS LLP, 1700 DIAGONAL RD, SUITE 310, ALEXANDRIA, VA, 22314-2848, US

(73) Assignee: Mitsubishi Heavy Industries, Ltd., Tokyo (JP)

(21) Appl. No.: 11/990,187

(22) PCT Filed: Feb. 16, 2007
(86) PCT No.: PCT/JP2007/052869

§ 371 Date: Feb. 8, 2008

(30) Foreign Application Priority Data
Feb. 28, 2006 (JP) 2006-051449

(51) Int. Cl. B41L 49/00; F15B 13/00

(52) U.S. Cl. 101/480; 137/561 R

(57) ABSTRACT

It is the object to provide a printing press having no fear of interruption of printing operation and also having a structure by which the utilization efficiency thereof is increased. A printing press is provided that includes a plurality of blowers each having an air supply tube for supplying air, a header pipe to which the air supply tubes of all the blowers are connected, and a plurality of air showers for executing predetermined processes using air supplied from the header pipe through pneumatic tubing, by which the respective air showers are connected to the header pipe.

### CROSS-REFERENCE TO RELATED APPLICATIONS

The present Application is based on International Application No. PCT/JP 2007/52869, filed on Feb. 16, 2007, which in turn corresponds to Japanese Application No. 2006-051449 filed on Feb. 28, 2006, and priority is hereby claimed under 35 USC §119 based on these applications. Each of these applications are hereby incorporated by reference in their entirety into the present application.

### TECHNICAL FIELD

The present invention relates to a printing press.

### BACKGROUND ART

Various types of air jetting means for adjusting the position of sheets being transported are used in sheet-fed printing presses.

For example, in the case that thick sheets (thick papers) are handled, the sheets are pushed against an impression cylinder by air showers (air jets) to prevent an end portion of each of the sheets from bouncing on the impression cylinder.

Also, in the case that thin sheets (thin papers) are handled on a sheet-fed printing press equipped with skeleton type intermediate cylinders, the sheets are prevented from leaping by air flow generated on the surface of air chambers, which are provided along the sheet transfer path around each of the intermediate cylinders. In a sheet-fed printing press for dual-purpose of thin sheet/thick sheet printing as shown in Patent Document 1, for example, air showers used for thick papers or air chambers for thin papers is selectively used by a switching valve.

In addition, there is a case that air jetting is used for adjusting the position of sheets on a chain gripper.

Patent Document 1: Japanese Unexamined Patent Application, Publication No. 2001-293843

### DISCLOSURE OF INVENTION

Incidentally, the air source of those air jetting means is a pneumatic machine such as a blower or the like, and only one unit of the pneumatic machine is provided for air showers or air chambers.

Therefore, there is a problem that the air showers or air chambers become not available when the pneumatic machine fails, and printing operation remains interrupted until the machine is repaired or replaced.

There is also a problem that, since a pneumatic machine having a big capacity tends to be used for allowing a margin to the air volume needed for the printing press, the utilization efficiency of the pneumatic machine becomes worse.

The present invention addresses the above problems with the object of providing a printing press having no fear of interruption of printing operation and also having a structure by which the utilization efficiency thereof is increased.

In order to solve the above problems, the following means are employed in the present invention.

That is, in the present invention, a printing press consisting of a plurality of pneumatic machines each having an air supply tube for supplying air, a tank body to which the air supply tubes of all the pneumatic machines are connected, and a plurality of air utilization means for executing predetermined processes using air supplied from the tank body through pneumatic tubing, by which the respective air utilization means are connected to the tank body.

According to the present invention, air is collected from the plurality of pneumatic machines into the tank body through the air supply tubes, and the collected air is fed to each of the air utilization means through the respective pneumatic tubing. Each of the air utilization means executes predetermined processes needed for printing operation using the air.

Since air from the plurality of pneumatic machines is thus collected and used by the plurality of air utilization means, even when one of the pneumatic machines fails, the remaining pneumatic machines can supply air to the plurality of air utilization means. Accordingly, the printing operation can be continuously carried out without interruption.

In addition, since the margin to the air volume used by the plurality of air utilization means can be allowed by the plurality of pneumatic machines, the capacity of each pneumatic machine can be reduced and the utilization efficiency of the pneumatic machines can be improved.

Moreover, since the air volume supplied to the air utilization means can be reduced by stopping some of the plurality of pneumatic machines, it becomes possible to control the capacity of the pneumatic machines by on/off of some of them without discharging excess air; thereby power-conservation can be achieved.

In the above invention, it is preferable that the tank body has a tubular structure and is installed to extend in the moving direction of printing sheets.

Since having a tubular structure and being installed to extend in the moving direction of printing sheets, the tank body can be adapted to the air utilization means installed at separated positions in the moving direction of printing sheets.

In the above invention, it is also preferable that the tank body is constructed by combining a supply module including a plurality of attachment members, to which the air supply tubes are attached, and a predetermined number of utilization modules each including only a connection member for the pneumatic tubing.

Since being constructed by combining the supply module including the plurality of attachment members, to which the air supply tubes are attached, and a predetermined number of utilization modules each including only a connection member for the pneumatic tubing, the tank body can be adapted to sheet-fed printing presses having different length in the moving direction of the printing sheets by adjusting the number of the utilization modules.

Moreover, since the pneumatic machines are collectively disposed near the supply module, inspection work therefor can be easily carried out.

In this case, it is preferable that the supply module is provided with a connection member for the pneumatic tubing; thereby it becomes possible to use air utilization means when located near the supply module.

In the above construction, it is preferable that the supply module is disposed on the side of a sheet feeding apparatus or on the side of a sheet delivery apparatus.

Since the supply module is thus disposed on the side of a sheet feeding apparatus or on the side of a sheet delivery apparatus, the pneumatic machines are located near the sheet feeding apparatus or sheet delivery apparatus, where a worker is present.

Accordingly, the worker can quickly approach the pneumatic machines and easily do inspection work therefor.

In the above invention, it is also preferable that the pneumatic tubing is provided with control valves therein, the open/close degree of which can be remotely controlled.

Since the pneumatic tubing is thus provided with control valves therein, the open/close degree of which can be remotely controlled, it is possible, for example, to supply the air volume needed for each of the air utilization means by operating the respective control valves from a control section.

According to a printing press of the present invention, since air from the plurality of pneumatic machines is collected into the tank body and used by the plurality of air utilization means, even when one of the pneumatic machines fails, the printing operation can be continuously carried out without interruption.

In addition, since the margin to the air volume used by the plurality of air utilization means can be allowed by the plurality of pneumatic machines, the capacity of each pneumatic machine can be reduced and the utilization efficiency of the pneumatic machines can be improved.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF DRAWINGS

The present invention is illustrated by way of example, and not by limitation, in the figures of the accompanying drawings, wherein elements having the same reference numeral designations represent like elements throughout and wherein:

FIG. 1 is an elevation view showing a general structure of a sheet-fed printing press according to a first embodiment of the present invention, seen from its drive side.

FIG. 2 is a cross-section view taken from line X-X of FIG. 1.

FIG. 3 is an elevation view showing a general structure of an air utilization system according to the first embodiment of the present invention, seen from its drive side.

FIG. 4 is an elevation view showing a general structure of an air utilization system according to a different embodiment of the present invention, seen from its drive side.

FIG. 5 is an elevation view showing a general structure of an air utilization system according to a further different embodiment of the present invention, seen from its drive side.

FIG. 6 is a schematic view showing the structure of an intermediate cylinder portion according to a second embodiment of the present invention.

FIG. 7 is a cross-section view taken from line Y-Y of FIG. 6.

FIG. 8 is an elevation view showing a general structure of an air utilization system according to the second embodiment of the present invention, seen from its drive side.

FIG. 9 is a cross-section view taken from line Z-Z of FIG. 8.

### EXPLANATION OF REFERENCE SIGNS

1: sheet-fed printing press
3: sheet feeding apparatus
5: printing section
7: sheet delivery apparatus
11: sheet
35: blower
37: header pipe
39: air shower
47, 95: attachment member
49: air supply tube
51, 85: connection member
59, 87: control valve
53: pneumatic tubing
63: air chamber
71: chamber-air supply tube

### BEST MODE FOR CARRYING OUT THE INVENTION

Embodiments of the present invention will be described below with reference to the attached drawings.

### First Embodiment

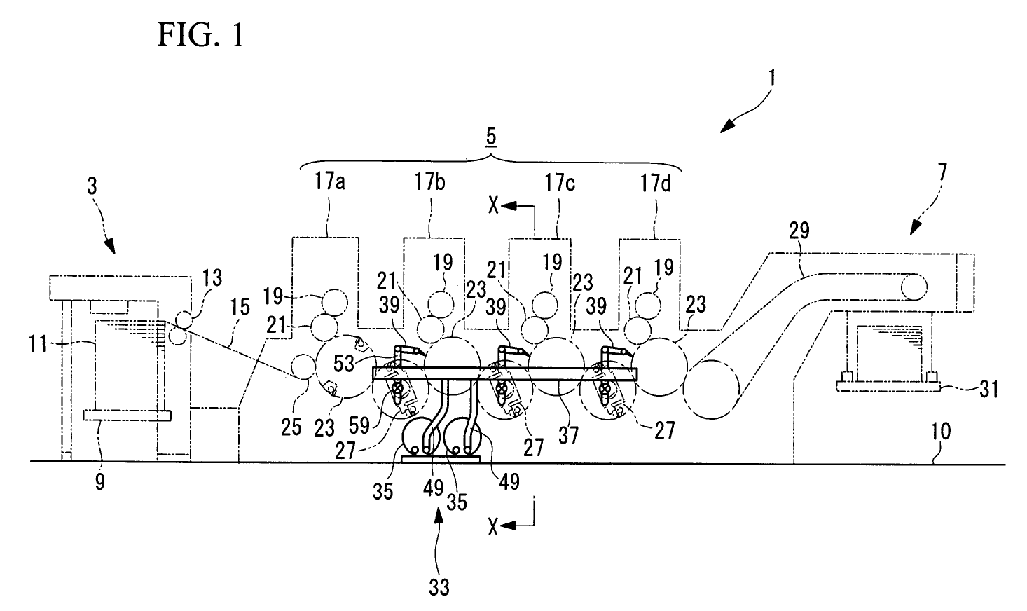

A first embodiment of the present invention will be described with reference to FIGS. 1 to 3.

This embodiment is an application of the present invention to a sheet-fed offset press (printing press) 1 for printing on thick sheets.

FIG. 1 is an elevation view of a general whole structure of the sheet-fed offset press 1 seen from its drive side.

The sheet-fed offset press 1 includes a sheet feeding apparatus 3, a printing section 5 and a sheet delivery apparatus (sheet delivery portion) 7.

The sheet feeding apparatus 3 includes a sheet feeding table 9, a sheet feeding mechanism (not shown), sheet feeding rollers 13 and a feeder board 15.

The sheet feeding table 9 is structured to be movable in an up-and-down direction, and holds sheets (printing sheets) 11 in a stacked state.

The sheet feeding mechanism picks up the sheets 11 one by one from a stack thereof and feeds them to the sheet feeding rollers 13.

The sheet feeding table 9 is constructed to move upward in response to the feeding of the sheets 11 so that the distance between the sheet feeding mechanism and the sheets 11 can be maintained substantially constant.

The sheet feeding rollers 13 are formed of a pair of rollers and have a function to feed the sheets 11, fed by the sheet feeding mechanism, onto the feeder board 15 by holding them between the rollers.

At the downstream end of the feeder board 15, there are provided a front gauge and a side gauge, both of which control the attitude and position of the sheets 11.

Further, on the downstream side of the feeder board 15, there is provided a transfer member such as, for example, a swing gripper or the like, which transfers the sheets 11 to the printing section 5 by allowing them to be accelerated.

The printing section 5 includes printing units 17a, 17b, 17c, 17d.

The printing units 17a, 17b, 17c, 17d print cyan, yellow, magenta and black, respectively; color printing is performed with use of colors obtained by mixing these colors.

Since the printing units 17a, 17b, 17c, 17d are provided for every color to be printed, the number of the units varies depending on the number of colors to be printed.

The printing unit 17a includes a plate cylinder 19, a rubber cylinder 21, an impression cylinder 23 and an intermediate cylinder 25. The intermediate cylinder 25 has a cylindrical shape.

Each of the printing units 17b, 17c, 17d includes a plate cylinder 19, a rubber cylinder 21, an impression cylinder 23 and an intermediate cylinder 27.

The plate cylinder 19, rubber cylinder 21 and impression cylinder 23 are disposed in this order from top to bottom so as to contact each other, and as shown in FIG. 1, the rubber cylinder 21 is located so as to deviate from the position directly above the impression cylinder 23 toward the upstream side in the direction of transporting the sheets 11.

A print plate for forming a print image is attached on the outer surface of the plate cylinder 19. Around the plate cylinder 19, although not shown, there are provided an ink apparatus for supplying ink onto an image line portion of the print plate and a dampening apparatus for supplying dampening water onto a non-image line portion of the print plate.

A blanket constructed of elastic material is attached on the outer surface of the rubber cylinder 21. The rubber cylinder 21 reprints a print image on the sheets 11, the print image having been formed on the print plate and reprinted from the plate cylinder 19 onto the rubber cylinder 21.

The impression cylinder 23 has a diameter being twice as much as that of the plate cylinder 19 and also the rubber cylinder 21; that is so called a double-sized cylinder.

On the outer surface of the impression cylinder 23, two gripper devices (not shown) are provided to be positioned across the center axis of the impression cylinder 23.

The intermediate cylinder 27 is disposed in the upstream side of the impression cylinder 23. The intermediate cylinder 27 is of a skeleton type and is provided with gripper devices at both ends thereof.

The sheets 11 are transported through the printing units 17a, 17b, 17c, 17d by being gripped by a series of gripper devices in the intermediate cylinders 25, 27 and impression cylinders 23.

The sheet delivery apparatus 7 includes a chain gripper 29 and a sheet delivery table 31.

The chain gripper 29, which includes a pair of chains circulating between a position adjacent to the impression cylinder 23 of the printing unit 17d and a position above the sheet delivery table 31, gripping bars connecting the pair of chains, and gripper devices attached to the respective gripping bars with a predetermined space, receives the sheets from the impression cylinder 23 of the printing unit 17d and transports them to the position above the sheet delivery table 31.

The sheet delivery table 31 is structured to be able to move in an up-and-down direction, and holds the sheets delivered from the chain gripper 29 in a stacked state.

The sheet delivery table 31 is controlled to move downward gradually so that the falling distance of the sheets would be substantially constant.

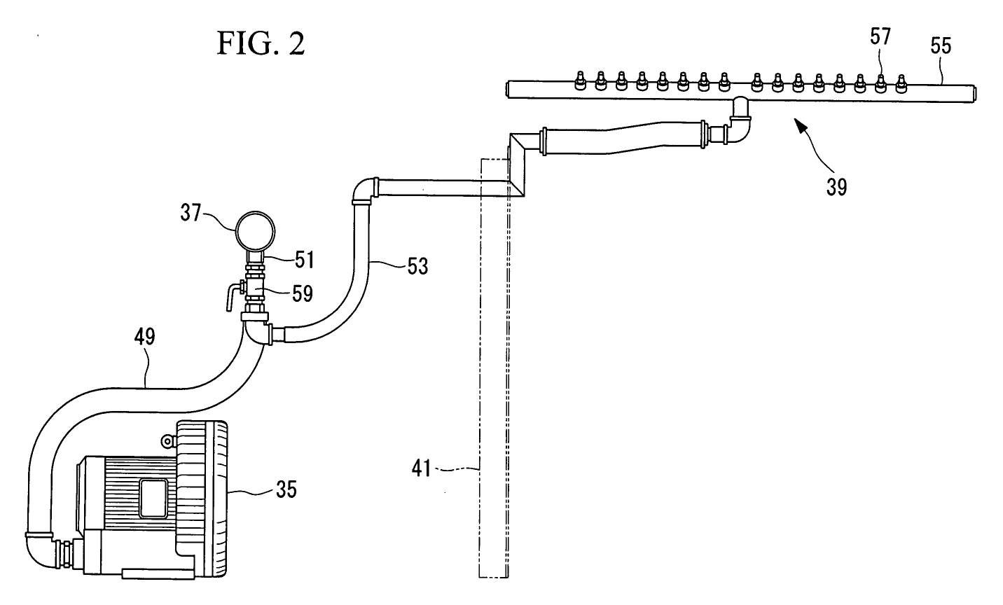

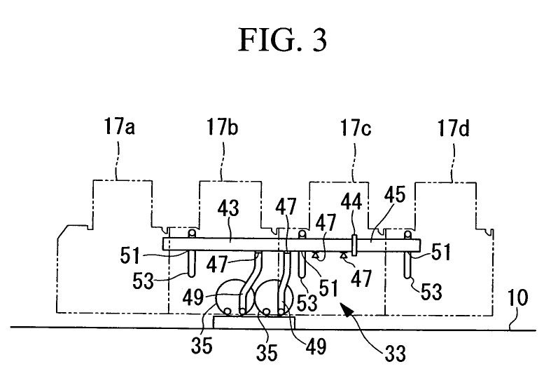

On the drive side of the printing section 5, there is provided an air utilizing system 33. The air utilizing system 33 will now be described with reference to FIGS. 2 and 3.

The air utilizing system 33 includes blowers (pneumatic machines) 35, a header pipe (tank body) 37 and air showers (air utilizing means) 39.

The header pipe 37 is installed on the outside of a drive side frame 41 of the sheet-fed offset press 1 by spacing apart therefrom so as to extend in the direction of transporting the sheets 11.

The header pipe 37 is disposed between the rear end of the printing unit 17a and the front of the printing unit 17d in a substantially horizontal position.

The header pipe 37 is composed of a supply module 43 and a first utilization module (utilization module) 45.

The supply module 43 and first utilization module 45 are both pipe members having a cylindrical shape and connected by a connecting flange 44 so as to become a through pipe.

The supply module 43 has a length extending from the rear end of the printing unit 17a to the rear of the printing unit 17c.

The supply module 43 is provided with attachment members 47 for connecting an air supply tube 49 of each of the blowers 35 at four positions apart from each other in a longitudinal direction on the underside thereof.

On the underside of the supply module 43, two connection members 51 for connecting pneumatic tubing 53 are fixed at positions corresponding to the respective front portion of the printing units 17b and 17c.

The first utilization module 45 has a length extending from the rear of the printing unit 17c to the front of the printing unit 17d and covers the length of one printing unit.

On the underside of the first utilization module 45, a connection member 51 for connecting the pneumatic tubing 53 is fixed at a position corresponding to the front portion of the printing unit 17d.

The printing units 17d, 17c, 17d are each provided with one unit of the air shower 39, which is installed at a position from the intermediate cylinder 27 to the rubber cylinder 21 so as to face the impression cylinder 23.

The air shower 39 includes a jet pipe 55, which has the substantially same length as that of the impression cylinder 23 and is disposed to extend along the axis line thereof, and jet nozzles 57 disposed at positions apart from each other by a predetermined space in a longitudinal direction on the jet pipe 55 so as to face the impression cylinder 23.

The jet pipe 55 is connected to the header pipe 37 using the pneumatic tubing 53.

On the header pipe 37 side of the pneumatic tubing 53, there is provided a control valve 59, the open/close degree of which can be remotely controlled.

Since being installed to extend in the moving direction of the sheets 11, the header pipe 37 can deal with the air showers 39 distributed in the moving direction of the printing sheets.

The number of units of the blower 35 is determined by considering the capacity to cover the maximum volume of air to be delivered to each of the three units of the air shower 39. In the case of this embodiment, two units of the blower 35 are provided.

One end of the air supply tube 49 of each of the blowers 35 is connected to one of the attachment members 47. The attachment members 47 having no air supply tube 49 connected thereto will be closed.

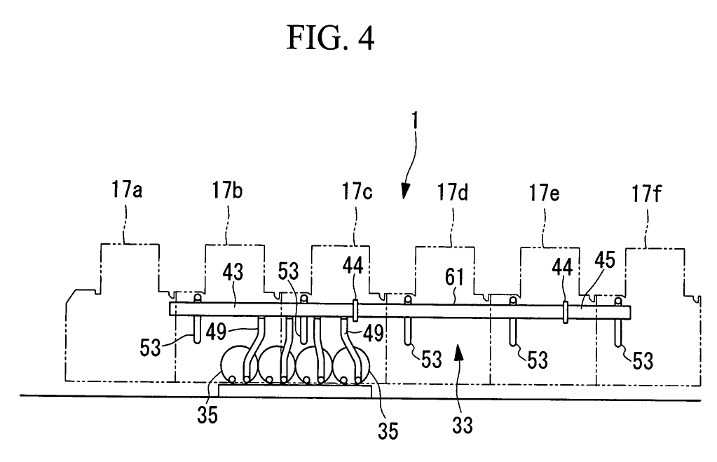

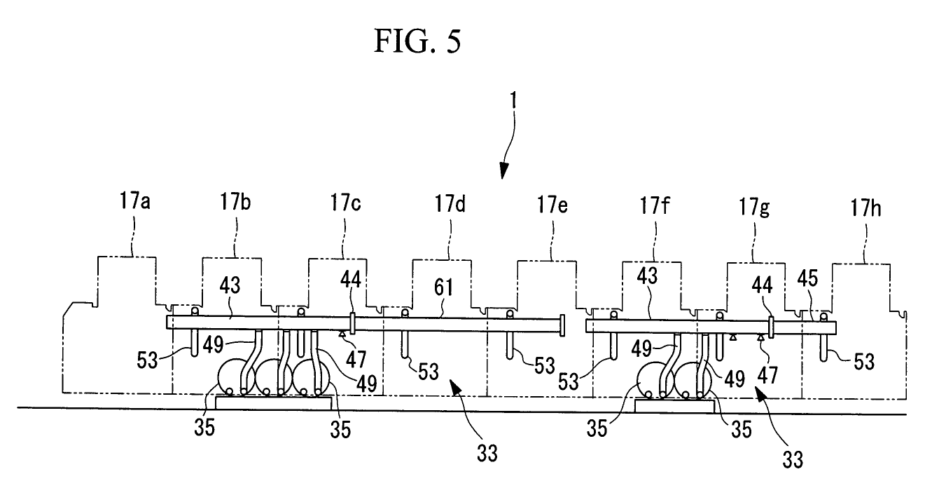

It is noted that although the first utilization module 45 is solely used in this embodiment, a second utilization module 61 is provided for the case that the number of printing unit is increased (see FIGS. 4 and 5).

The second utilization module 61 is provided with two connection members 51 for each connecting the pneumatic tubing 53, and covers two printing units.

The operation of the above sheet-fed offset press 1 according to this embodiment will now be described.

First, the printing operation of the sheet-fed offset press 1 will be described.

Thick sheets 11 loaded on the sheet feeding table 9 of the sheet feeding apparatus 3 are taken out from the top thereof one by one by the sheet feeding mechanism, and are fed to a nip portion of the sheet feeding rollers 13. The position of the sheets 11 transported on the feeder board 15 by the sheet feeding rollers 13 are adjusted by a front gauge and a side gauge provided at the downstream end of the feeder board 15.

The sheets stopped at the front gauge are gripped and swung by the swing gripper toward a continuously rotating intermediate cylinder 25 so as to be accelerated.

The respective sheets 11 gripped by the swing gripper are transferred to the gripper device of the intermediate cylinder 25 to be gripped thereby and are further transferred to the gripper device of the impression cylinder 23 to be gripped thereby.

In the printing unit 17a, a dampening apparatus supplies water onto a non-image line portion of a print plate attached on the outer surface of the plate cylinder 19, and an ink supplying apparatus supplies ink onto an image line portion of the print plate.

A print image on the print plate thus obtained is reprinted on the rubber cylinder 21.

The print image reprinted on the rubber cylinder 21 is reprinted on the respective sheets 11, which are transported by the impression cylinder 23; the printing of the first color is thus carried out.

The sheets 11 on which the first color has been printed in the printing unit 17a are transferred from the impression cylinder 23 of the printing unit 17a to the intermediate cylinder 27 of the printing unit 17b and further to the impression cylinder 23 of the printing unit 17b.

In the printing unit 17b, as with the printing unit 17a, a print image formed on the plate cylinder 19 and reprinted on the rubber cylinder 21 is reprinted on the sheets 11, and thereby the printing of the second color is carried out.

The same process as described above is repeated in the printing units 17c and 17d; color printing is thus performed.

After being printed in printing section 5, the sheets 11 are transferred from the impression cylinder 23 of the printing unit 17b to the chain gripper 29 to be gripped. The sheets transported by the chain gripper 29 are released at a position above the sheet delivery table 31, fall on the top of the sheet delivery table 31, and are piled thereon.

At this time, a powder is sprayed onto the sheets 11 to prevent undried ink from adhering onto the backside of the sheets 11.

Next, the operation of the air utilizing system 33 will be described.

Since a thick sheet 11 has strong elasticity, there is a fear that when the thick sheet is transferred from the skeleton type intermediate cylinder 27 to the impression cylinder 23, a free end portion of each of the sheets bounces on the impression cylinder 23 and hits the intermediate cylinder 27, which may cause a scratch thereon.

The air utilizing system 33 suppresses the bounce of the sheets.

During printing operation, two units of the blower 35 are driven and compressed air is taken in from the blowers 35 to the header pipe 37 via the air supply tubes 49.

The air collected in the header pipe 37 is taken in the jet pipes 55 via the pneumatic tubing 53 and is jetted from the jet nozzles 57 against the sheets being transported around the respective impression cylinders 23, and thereby the sheets are pushed onto the respective impression cylinders 23.

Since the air from two units of the blower 35 is thus collected in the header pipe 37 and used by three units of the air shower 39, even if one unit of the blower 35 fails, the remaining one unit of the blower 35 can supply air to the air showers 39 disposed at three places.

Accordingly, although the maximum volume of air cannot be delivered from the air showers 39, a minimal volume of air is secured, so the printing operation can be carried out without being interrupted.

Moreover, since a margin of air volume required for the three units of the air shower 39 is shared by the two units of the blower 35, the capacity of one blower unit can be reduced and the utilization efficiency of the blowers 35 can be thereby increased.

In addition, since the air volume supplied to the air showers 39 is reduced by halting one of two units of the blower 39, capacity control of the air showers 39 is accomplished only by on/off of the blower 35 without discharging excess air; thereby power-conservation can be achieved. The more the number of the blowers 35 increases, the more the merit of power-conservation becomes great.

It is possible to operate respective control valves 59 from a control section to implement a required printing by adjusting the air volume delivered to the respective air showers 39, the control section being located on the sheet delivery side to control the operation of the sheet-fed offset press 1 while watching the state of printed sheet.

In addition, since the supply module 43 is disposed on the side of the sheet feeding apparatus 3 and the blowers 39 are collectively disposed, a worker can easily approach the blowers 39 and do inspection work therefor.

Incidentally, further power-conservation can be achieved by using an inverter for controlling the motor for driving each of the blowers 35.

It should be noted that although being described to be applied to a sheet-fed offset press 1 for four-color printing in this embodiment, the present invention is not limited to this application.

For example, the present invention may be applied to a sheet-fed offset press 1 for six-color printing, which has six printing units 17a, 17b, 17c, 17d, 17e, 17f.

In this sheet-fed offset press 1, a header pipe 37 is constructed so as to cover from the printing unit 17b to the printing unit 17f by connecting a supply module 43, a second utilization module 61 and a first utilization module 45.

Four units of the blower 35 are provided, taking consideration of the capacity to cover the maximum volume of air delivered to each of the five units of the air shower 39.

The present invention may also be applied to a sheet-fed offset press 1 for eight-color printing, which has eight printing units 17a, 17b, 17c, 17d, 17e, 17f, 17g, 17h.

In this case, two systems of the air utilizing system 33 are employed, taking the pressure loss in the header pipe 37 into account.

In the air utilizing system 33 on the side of the sheet feeding apparatus 3, the header pipe 37 is constructed so as to cover from the printing unit 17b to the printing unit 17e by connecting a supply module 43 and a second utilization module 61.

Three units of the blower 35 are provided, taking consideration of the capacity to cover the maximum volume of air delivered to each of the four units of the air shower 39.

In the air utilizing system 33 on the side of the sheet delivery apparatus, the header pipe 37 is constructed so as to cover from the printing unit 17f to the printing unit 17h by connecting the supply module 43 and a first utilization module 45.

Two units of the blower 35 are provided, taking consideration of the capacity to cover the maximum volume of air delivered to each of the three units of the air shower 39.

Since being thus constructed by combining the supply module 43, first utilization module 45 and/or second utilization module 61, the header pipe 37 can be adapted to sheet-fed offset press 1 having different length in the moving direction of the printing sheets by adjusting the combination.

### Second Embodiment

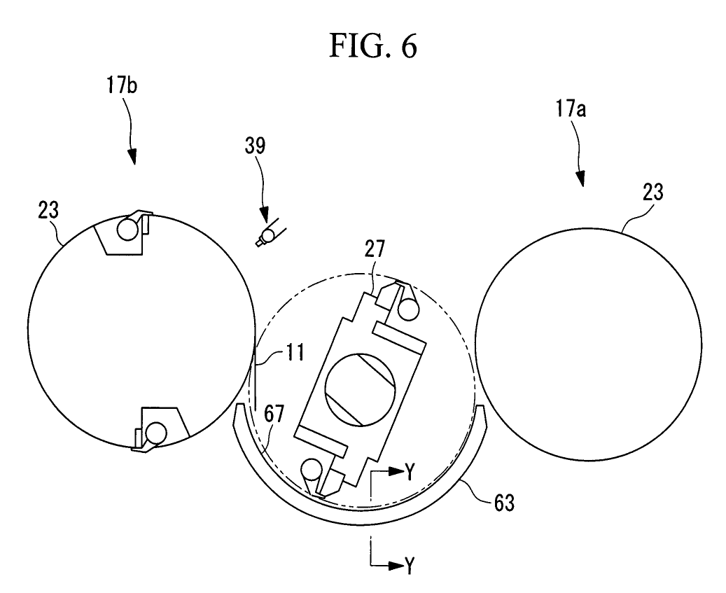

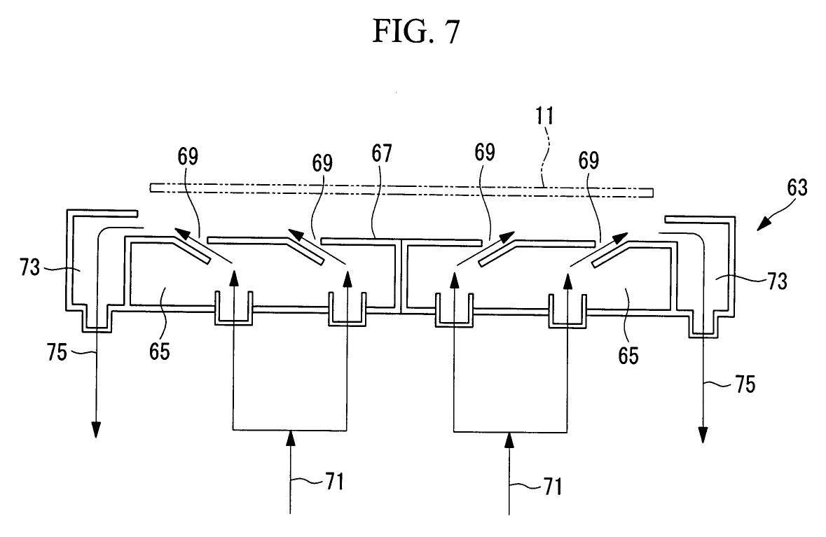

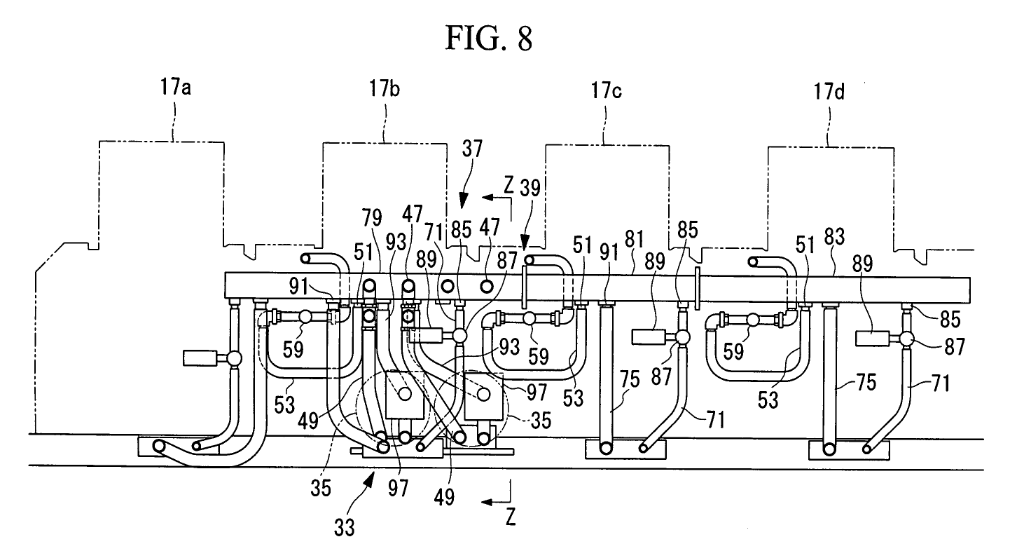

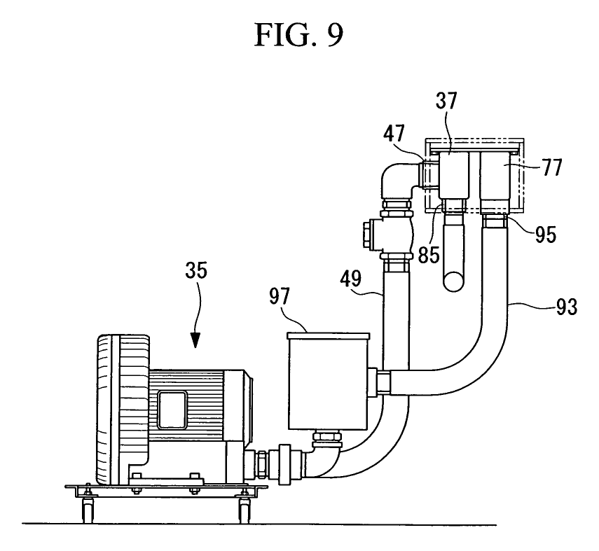

Next, a second embodiment of the present invention will be described with reference to FIGS. 6 to 9.

The basic structure of this embodiment is identical to that of the first embodiment except that a sheet-fed offset press 1 is provided with an air utilizing system 33 additionally having air chambers 63 for dual-purpose of thin sheet/thick sheet printing. Accordingly, only different points will be described in this embodiment, and duplicated description of the other part will be omitted.

The same constitutional elements as those in the first embodiment are indicated by identical reference characters, and detailed descriptions thereof are omitted.

A sheet-fed offset press 1 according to this embodiment is provided with air chambers 63 for guiding thin sheets 11 in addition to the structure of the first embodiment, the air chambers 63 being each disposed along a peripheral path of a skeleton type intermediate cylinder 27.

Each of the air chambers 63 is a box-like member curved in an arc shape of the peripheral path of the intermediate cylinder 27, as shown in FIG. 6.

Each of the air chambers 63 includes chambers 65, jet holes 69 and discharging portions 73. The chambers 65 have a width larger than that of the sheet 11 and are each constructed to extend in the moving direction of the sheets 11.

The intermediate cylinder 27 side of the chambers 65, 65 constitutes a guide surface 67 for guiding the sheets 11. On the guide surface 67, there are provide a multiple of jet holes 69 for jetting air in the chambers 65 outward at the upstream side in the direction of transporting the sheets 11.

A chamber-air supply tube (air supply tube) 71 for supplying air is connected to each of the chambers 65.

On both sides of the chambers 65, there are provided the discharging portions 73 for substantially recovering the air jetted from the jet holes 69.

Chamber recovery tubes 75 for drawing and recovering the air are connected to the discharging portions 73, respectively.

A header pipe 37 is a pipe member having a rectangular cross-sectional shape. On the printing unit 17 side of the header pipe 37, there is provided a suction header pipe 77 having the substantially same shape as the header pipe 37 with a space therefrom.

The header pipe 37 is composed of a supply module 79, a first utilization module 81 and a second utilization module 83 so as to become a through pipe.

The supply module 79 is provided with attachment members 47 for connecting respective air supply tubes 49 of the blowers 35 at four positions apart from each other in a longitudinal direction on the outer side thereof.

On the underside of the supply module 43, a connection member 51 for connecting pneumatic tubing 53 is fixed at a position corresponding to the front portion of the printing unit 17b, and a connection member 85 for connecting a chamber-air supply tube 71 is also fixed at a position corresponding to the rear portion of the printing unit 17b.

On the underside of the first utilization module 81, the connection member 51 for connecting the pneumatic tubing 53 is fixed at a position corresponding to the front portion of the printing unit 17c, and the connection member 85 for connecting the chamber-air supply tube 71 is also fixed at a position corresponding to the rear portion of the printing unit 17c.

On the underside of the second utilization module 83, the connection member 51 for connecting the pneumatic tubing 53 is fixed at a position corresponding to the front portion of the printing unit 17d, and the connection member 85 for connecting the chamber-air supply tube 71 is also fixed at a position corresponding to the rear portion of the printing unit 17d.

On the header pipe 37 side of each of the chamber-air supply tubes 71, there are provided a control valve 87, an open/close degree of which can be remotely controlled, and a silencer 89.

Connection members 91 for each connecting a chamber recovery tube 75 are fixed on the underside of the suction header pipe 77.

The suction header pipe 77 is connected to the suction side of the blowers 35 by air suction tubes 93.

The air suction tubes 93 are each connected to an attachment member 95 provided on the underside of the suction header pipe 77.

A filter 97 for collecting waste, dirt, dust and the like, which are included in the suction air, is installed in midstream of the air suction tube 93.

The operation of the sheet-fed offset press 1 constituted as described above, according to this embodiment, will now be described.

The printing operation and the operation of the air utilizing system 33 in the case of thick sheets 11 are identical to those of the first embodiment, so duplicated description will be omitted and the operation of the air utilizing system 33 in the case of thin sheets 11 will be described.

In the case when the thin sheets 11 are handled, the control valves 59 are closed so that air is not supplied to the air showers 39.

Then, the degree of opening of respective control valves 87 is regulated so that the air is supplied to the chambers 65, 65 through the chamber-air supply tubes 71.

During printing operation, two units of the blower 35 are driven and compressed air is taken in from the blowers 35 to the header pipe 37 via the air supply tubes 49.

The air collected in the header pipe 37 is taken in the chambers 65 through the respective chamber supply tubes 71. The air taken into the chambers 65 is jetted from jet holes 69, flows along the guide surface 67 toward the upstream side in the sheet transport direction and also toward the outside of the sheets, and is recovered into the discharging portions 73.

The sheets being transported around the intermediate cylinder 27 are attracted to the air flow flowing along the guide surface 67, pulled toward the upstream side in the sheet transport direction and also toward the outside of the sheets, controlled their position, and transferred to the next impression cylinder 23.

The air recovered into the discharging portions 73 is collected to the suction header pipe 77 through the chamber recovery tubes 75.

The air collected to the suction header pipe 77 is taken into the suction side of each of the blowers through the air suction tubes 93; the dust or the like in the air is removed in midstream by the filter 97.

It is possible to operate the respective control valves 87 from a control section to implement a required printing by adjusting the air volume delivered to the respective air chambers 63, the control section being located on the sheet delivery side to control the operation of the sheet-fed offset press 1 while watching the state of printed matter.

The processes and effects described as to the operation of the air utilizing system 33 of the first embodiment are similarly applied to the case of the sheet-fed offset press 1 according to this embodiment, so duplicated description will be omitted here.

Since being constructed by combining the supply module 79, first utilization module 81 and/or second utilization module 83, the header pipe 37 is adaptable to sheet-fed offset press 1 having different length in the moving direction of the printing sheets by adjusting the combination similarly as with the first embodiment.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A printing press comprising:
a plurality of pneumatic machines each having an air supply tube for supplying air;
a tank body to which the air supply tubes of all the pneumatic machines are connected; and
a plurality of air utilization means for executing predetermined processes using air supplied from the tank body through pneumatic tubing, by which the respective air utilization means are connected to the tank body.

2. The printing press according to claim 1,
wherein the tank body has a tubular structure and is installed to extend in the moving direction of printing sheets.

3. The printing press according to claim 1,
wherein the tank body is constructed by combining a supply module including a plurality of attachment members, to which the air supply tubes are attached, and a predetermined number of utilization modules each including only a connection member for the pneumatic tubing.

4. The printing press according to claim 3,
wherein the supply module includes a connection member for the pneumatic tubing.

5. The printing press according to claim 3,
wherein the supply module is disposed on the side of a sheet feeding apparatus or on the side of a sheet delivery apparatus.

6. The printing press according to any one of claim 1,
wherein the pneumatic tubing is provided with control valves therein, the open/close degree of which can be remotely controlled.

7. The printing press according to claim 2,
wherein the tank body is constructed by combining a supply module including a plurality of attachment members, to which the air supply tubes are attached, and a predetermined number of utilization modules each including only a connection member for the pneumatic tubing.

8. The printing press according to claim 4,
wherein the supply module is disposed on the side of a sheet feeding apparatus or on the side of a sheet delivery apparatus.

9. The printing press according to any one of claim 2,
wherein the pneumatic tubing is provided with control valves therein, the open/close degree of which can be remotely controlled.

10. The printing press according to any one of claim 3,
wherein the pneumatic tubing is provided with control valves therein, the open/close degree of which can be remotely controlled.

11. The printing press according to any one of claim 4,
wherein the pneumatic tubing is provided with control valves therein, the open/close degree of which can be remotely controlled.

12. The printing press according to any one of claim 5,
wherein the pneumatic tubing is provided with control valves therein, the open/close degree of which can be remotely controlled.
